(19) United States
(12) Patent Application Publication
(10) Pub. No.: US 2015/0100281 A1
(43) Pub. Date: Apr. 9, 2015

(54) METHOD AND DEVICE FOR CREATING A SYSTEM LAYOUT OF A FREE-FIELD PHOTOVOLTAIC POWER PLANT WITH ARRAY SOLAR TRACKERS

(71) Applicant: SIEMENS AKTIENGESELLSCHFT, MÜNCHEN (DE)

(72) Inventor: Rafael Fink, Munchen (DE)

(21) Appl. No.: 14/396,840

(22) PCT Filed: Mar. 15, 2013
(86) PCT No.: PCT/EP2013/055330

§ 371 Date: Oct. 24, 2014

(30) Foreign Application Priority Data
May 2, 2012 (EP) 12166383.5

(51) Int. Cl. G06F 17/50

(52) U.S. Cl. CPC G06F 17/5004
USPC 703/1

(57) ABSTRACT

Provided herein is a method and a device for creating a system layout of a photovoltaic open-space power plant, which includes power plant components, in particular solar trackers, having the following method steps: providing configuration data which specifies the photovoltaic open-space power plant and the power plant components thereof, and providing configuration rules which are preset for the photovoltaic open-space power plant, and providing configuration parameters which put the configuration rules in concrete terms; and initialising and subsequently optimising a selection of, and an allocation of location to, necessary power plant components for the system layout properties of the photovoltaic open-space power plant by the configuration data provided and the configuration rules put into concrete terms for creating the system layout of the photovoltaic open-space power plant.

### CROSS-REFERENCE TO RELATED APPLICATIONS

This application claims priority to PCT Application No. PCT/EP2013/055330, having a filing date of Mar. 15, 2013, the entire contents of which are hereby incorporated by reference.

### FIELD OF TECHNOLOGY

The following relates to a method and a device for creating a system layout of a photovoltaic open-space power plant having power plant components, in particular solar trackers.

### BACKGROUND

The location-based planning and installation of photovoltaic open-space power plants is a bottleneck in conventional development methods. The layout of photovoltaic systems is individually designed for each system in conventional development methods with the aid of spreadsheet-based planning which is manually carried out by experts, or is created in full by a planner.

These conventional methods are very time-consuming and also prone to error on account of the enormous volume of data. On account of the prerequisites which always change from system to system, for example the outline of the area to be planned, regional regulations or the like, it is not possible to reuse or adapt photovoltaic open-space power plants which have already been designed in the planning of other systems, with the result that comprehensive, independent planning needs to be carried out for each system.

In the rough planning of systems which is needed to prepare a tender, generally important aspects are disregarded on account of the frequently brief submission period, which aspects are then dealt with only during detailed planning. This naturally means a large uncertainty factor with regard to the promises made in the tender.

The planners previously received software support only when choosing certain configuration parameters. For example, software tools which can be used to determine the dependence of the power of a photovoltaic open-space power plant on solar irradiation data and on the position of the area to be planned for the photovoltaic open-space power plant are known.

DE 33 01 046 C1 describes tracking devices which make it possible to orient devices according to an arcuate path. The tracking devices described there are suitable, for example, for solar devices such as photovoltaic generators, solar cookers and heliostats. In this case, the devices to be tracked are normally arranged such that they can be rotated about a vertical axis, in which case the required tilting about a horizontal axis is inevitably achieved with the rotation about the vertical axis by means of at least one guide element. The guide element of the tracking devices described there connects the tracked part with a fixed support point.

DE 203 14 665 U1 describes an arrangement for two-dimensionally covering area elevations such as bulk material or spoil heaps, noise protection walls or flood dams or other open spaces having an at least partially inclined and/or curved surface, in which case a supporting structure for accommodating covering elements is provided, which supporting structure is fitted with at least one covering element, which are arranged at a distance from the surface of the area elevation and at least partially cover the surface of the area elevation.

### SUMMARY

An aspect relates to a method and a device which, in accordance with configuration rules and configuration parameters, makes it possible to plan and install a photovoltaic open-space power plant with solar trackers on the basis of specified configuration and area data.

Embodiments of the invention therefore provide a method for creating a system layout of a photovoltaic open-space power plant having power plant components, in particular solar trackers, having the following method steps.

As a first method step, configuration data which specify the photovoltaic open-space power plant and its power plant components, and configuration rules which are predefined for the photovoltaic open-space power plant, and configuration parameters which concretize the configuration rules are provided.

In a second method step, a selection and positioning of required power plant components are initialized and subsequently optimized for system layout properties of the photovoltaic open-space power plant using the provided configuration data and the concretized configuration rules for creating the system layout of the photovoltaic open-space power plant.

According to another aspect, embodiments of the invention provides a device for creating a system layout of a photovoltaic open-space power plant having power plant components, in particular solar trackers, the device having an optimization module.

The device is designed to provide configuration data which specify the photovoltaic open-space power plant and power plant components, configuration rules which are predefined for the photovoltaic open-space power plant, and configuration parameters which concretize the configuration rules.

The device is also designed to initialize and then optimize a selection and positioning of required power plant components for system layout properties of the photovoltaic open-space power plant using the provided configuration data and the concretized configuration rules in order to create the system layout of the photovoltaic open-space power plant.

An idea on which embodiments of the invention are based is to provide planning software which makes it possible to automatically calculate the system layout, inter alia, while optimizing the connection of power plant components and optimizing the layout of photovoltaic open-space power plants having solar trackers.

In this case, the factors which are decisive for planning the layout of a system are optimized, that is to say, the placement of the power plant components using the area available for the photovoltaic open-space power plant.

In this case, the technical challenge is, on the one hand, the correct modeling of the subproblems of a problem to be solved and, on the other hand, the speed at which such solutions can be calculated in an automated manner on a computer.

A short calculation duration is an important factor in this case. The method according to embodiments of the invention calculates an optimized layout even for large systems within a few minutes and makes it possible to significantly reduce the planning time in comparison with the manual planning previously carried out.

A graphical user interface provides all of the functionalities needed to plan the system of the photovoltaic open-space power plant in a user-friendly manner, inter alia, the input of data, the optimization core, the visualization of the solution and the export of the results for further processing in computer-aided design or cost calculation tools.

The complete optimization problem addressed by the method according to embodiments of the invention has a high degree of complexity and is therefore solved by means of a hierarchical approach, that is to say, decomposition of the problem into subunits. Even the individual problems produced by the decomposition are sometimes difficult to solve and require the provision of specialized and complex calculation methods.

The problem addressed by the method according to embodiments of the invention comprises an optimizer which is in the form of a plurality of technical algorithms which are used to solve the overall problem.

Configuration rules are, on the one hand, physical secondary conditions which must be complied with and, on the other hand, rules which have been stipulated with regard to standardizing the system layouts or for the purpose of facilitating the construction of the system of the photovoltaic open-space power plant and servicing by experts.

The configuration rules are concretized by stipulating specific values for configuration parameters. The configuration data specify the photovoltaic open-space power plant to be planned and the power plant components of the photovoltaic open-space power plant.

As the configuration of the photovoltaic open-space power plant, it is necessary to create a system layout, that is to say, to place the solar trackers with the photovoltaic modules, to position service and cable routes between the solar trackers, to place inverters, and to assign the solar trackers to so-called inverter groups.

In order to calculate the system layout of the photovoltaic open-space power plant, system layout and connection problems of the configuration of the photovoltaic open-space power plant, which have been hierarchically subdivided into substeps, need to be solved for different system layout properties of the photovoltaic open-space power plant.

According to the optimization task, a suitable, optimized system layout is calculated in a short time, that is to say within a few minutes, in an automated manner taking into account the configuration rules.

In this case, objectives may be, for example, the best possible use of the available area or the creation of the best possible prerequisites for simple, efficient and cost-effective cabling of the power plant components of the photovoltaic open-space power plant.

The optimization task involves calculating a system layout of the photovoltaic open-space power plant, which is optimized in terms of nominal power, efficiency and costs, taking into account the configuration rules in a short time, that is to say within a few minutes.

In order to create the system layout of the photovoltaic open-space power plant, one possible embodiment of the method according to the invention provides for a path configuration of the photovoltaic open-space power plant to be calculated for the purpose of optimizing one of the system layout properties. This allows the cable and service routes to be advantageously planned.

In order to create the system layout of the photovoltaic open-space power plant, one possible embodiment of the method according to the invention provides for a number of the power plant components of the photovoltaic open-space power plant to be calculated for the purpose of optimizing one of the system layout properties.

In order to create the system layout of the photovoltaic open-space power plant, one possible embodiment of the method according to the invention provides for positioning of the solar trackers of the photovoltaic open-space power plant to be calculated for the purpose of optimizing one of the system layout properties. This results in advantageous configurations of the photovoltaic open-space power plant with improved solutions to the system layout and connection problems to be solved in the photovoltaic open-space power plant. On the basis of the calculated positioning, the solar trackers can be assigned to inverter groups which are as compact as possible in terms of their extent.

In order to create the system layout of the photovoltaic open-space power plant, one embodiment of the method according to the invention provides for an assignment of the solar trackers to inverter groups of the power plant components of the photovoltaic open-space power plant to be calculated for the purpose of optimizing one of the system layout properties. Cabling of the power plant components which is as simple, efficient and cost-effective as possible can therefore be advantageously provided within the inverter groups.

One embodiment of the method according to the invention provides for the calculation of the positioning of the solar trackers of the photovoltaic open-space power plant and the calculation of the assignment of the solar trackers to the inverter groups to be repeatedly alternately carried out during a local improvement method. As a result, calculated layouts can be advantageously gradually improved with respect to their quality.

An alternative embodiment of the method according to the invention provides for the number of solar trackers of the photovoltaic open-space power plant to be maximized for the purpose of optimizing one of the system layout properties. This makes it possible to increase the total power of the photovoltaic open-space power plant.

One embodiment of the method according to the invention provides for the creation of the system layout of the photovoltaic open-space power plant to comprise checking the compatibility of the provided power plant components with one another. This makes it possible to increase the operational reliability of the photovoltaic open-space power plant.

One possible embodiment of the method according to the invention provides for data relating to a position and an outline of an area intended for the photovoltaic open-space power plant to be provided as the configuration data. This advantageously makes it possible to optimally adapt the photovoltaic open-space power plant to the local conditions.

One possible embodiment of the method according to the invention provides for an optimization module having a plurality of algorithms to be used to create the system layout of the photovoltaic open-space power plant, which optimization module uses a plurality of calculation methods which are used to plan and install the photovoltaic open-space power plant in order to optimize different system layout properties.

One possible embodiment of the method according to the invention provides for a user interface module to be used to carry out the method, which user interface module is in the form of a graphical user interface and/or has functionalities for inputting data and/or for managing data and/or for outputting data and/or is designed to call the optimization module and/or to display results. This enables secure and simple data communication between the user and the planning software.

One possible embodiment of the method according to the invention provides for at least one of the algorithms in the optimization module to be designed to maximize a number of the solar trackers of the photovoltaic open-space power plant using a target function.

The refinements and developments described can be combined with one another in any desired manner if useful.

Further possible refinements, developments and implementations of embodiments of the invention also comprise not explicitly mentioned combinations of features of the embodiments of the invention which were described above or are described below with respect to the exemplary embodiments.

### BRIEF DESCRIPTION

The accompanying drawings are intended to provide a further understanding of the embodiments of the invention. They illustrate embodiments and, in conjunction with the description, are used to explain principles and concepts of embodiments of the invention.

Other embodiments and many of the advantages mentioned emerge with respect to the drawings. The illustrated elements of the drawings are not necessarily shown true to scale with respect to one another.

Some of the embodiments will be described in detail, with reference to the following figures, wherein like designations denote like members, wherein,

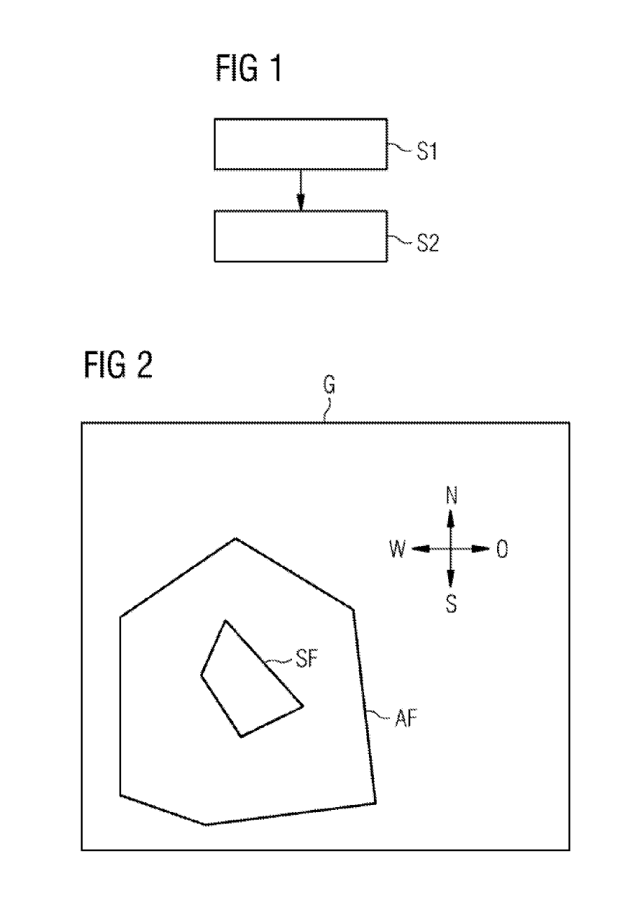

FIG. 1 shows an illustration of a flowchart of one possible embodiment of the method for creating a system layout of a photovoltaic open-space power plant;

FIG. 2 shows an illustration of a map view of an area to be planned for a photovoltaic open-space power plant according to one possible embodiment of the device;

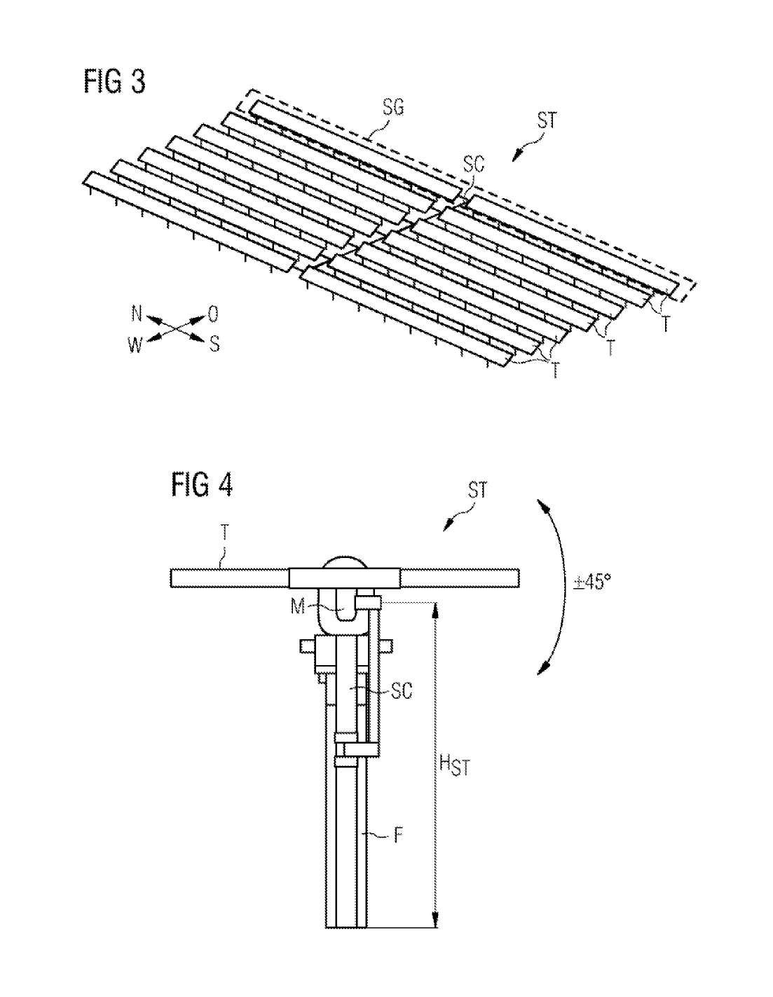

FIG. 3 shows an illustration of a solar tracker of a photovoltaic open-space power plant according to one possible embodiment of the device;

FIG. 4 shows an illustration of a solar tracker of a photovoltaic open-space power plant according to one possible embodiment of the device;

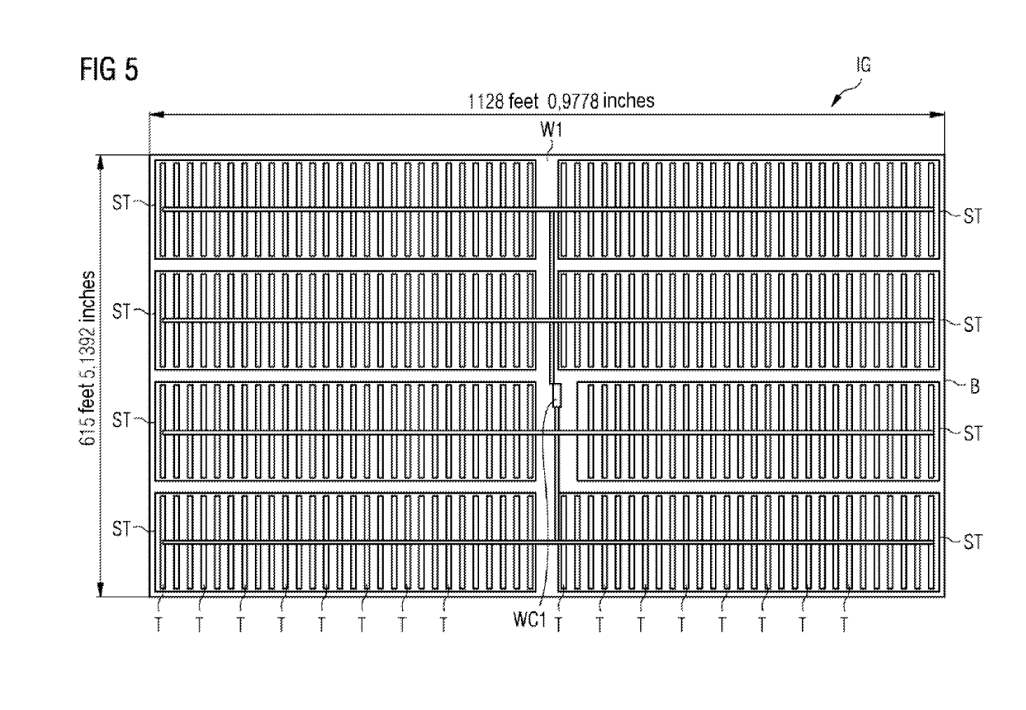

FIG. 5 shows an illustration of an inverter group of a photovoltaic open-space power plant according to one possible embodiment of the device;

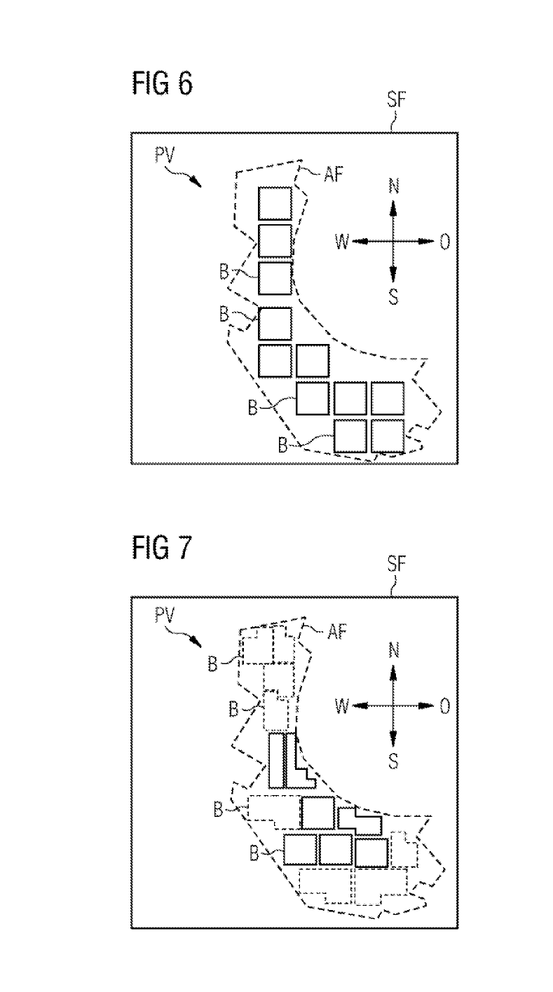

FIGS. 6-7 each show an illustration of possible system layouts which, according to one possible embodiment of the device, result from different specifications with respect to the arrangement of the solar trackers in the inverter groups;

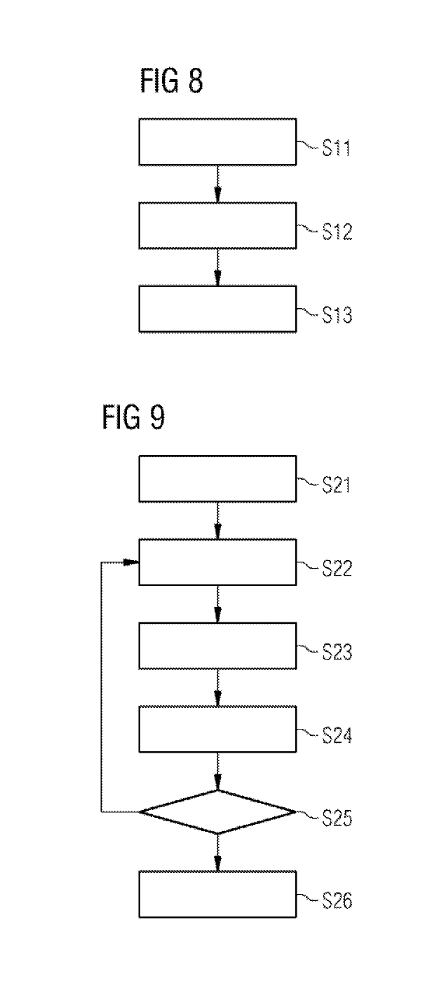

FIG. 8 shows an illustration of a flowchart of one possible embodiment of the method for creating a configuration of a photovoltaic open-space power plant with solar trackers which are arranged in standard blocks;

FIG. 9 shows an illustration of a flowchart of one possible embodiment of the method for creating a configuration of a photovoltaic open-space power plant with solar trackers which can be combined in any desired manner in inverter groups;

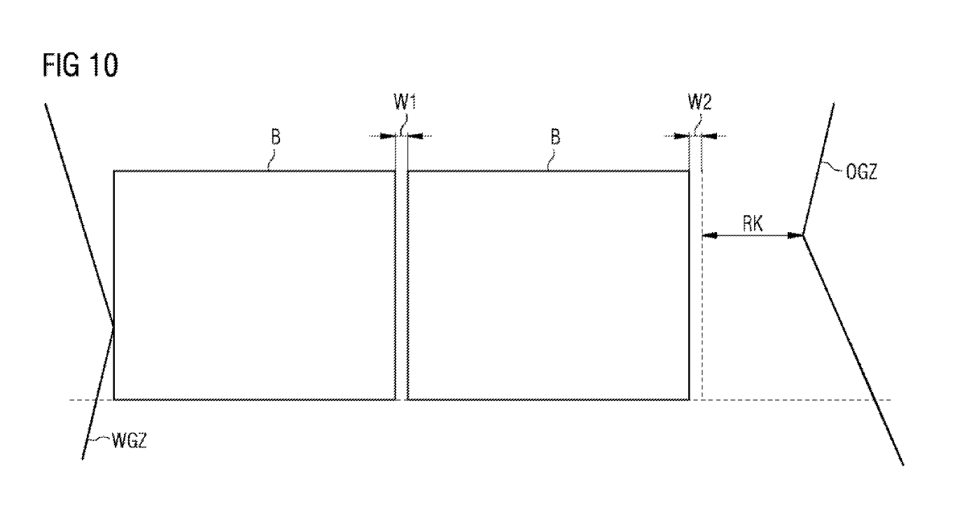

FIG. 10 shows an illustration of a detailed excerpt for placing the solar trackers or standard blocks according to one possible embodiment of the method;

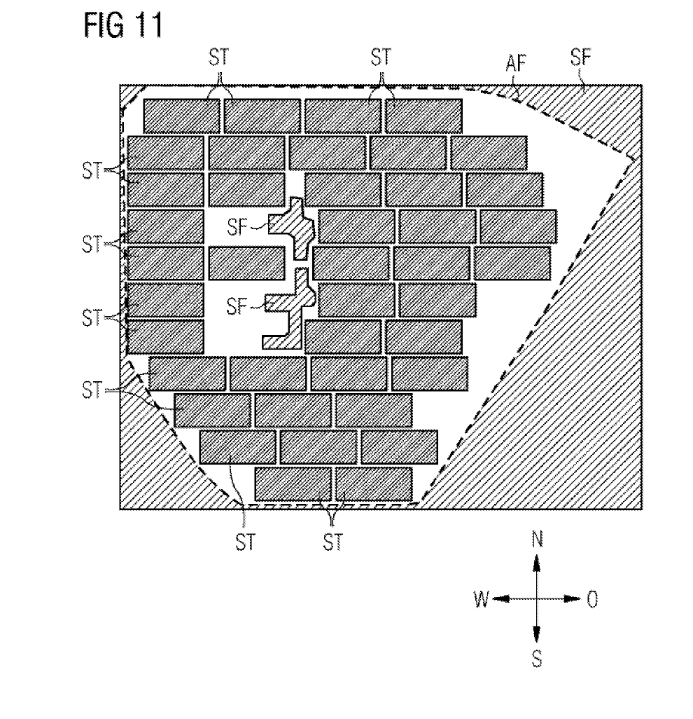

FIG. 11 shows a detailed excerpt of a first possible system layout of a configuration of a photovoltaic open-space power plant according to one possible embodiment of the method;

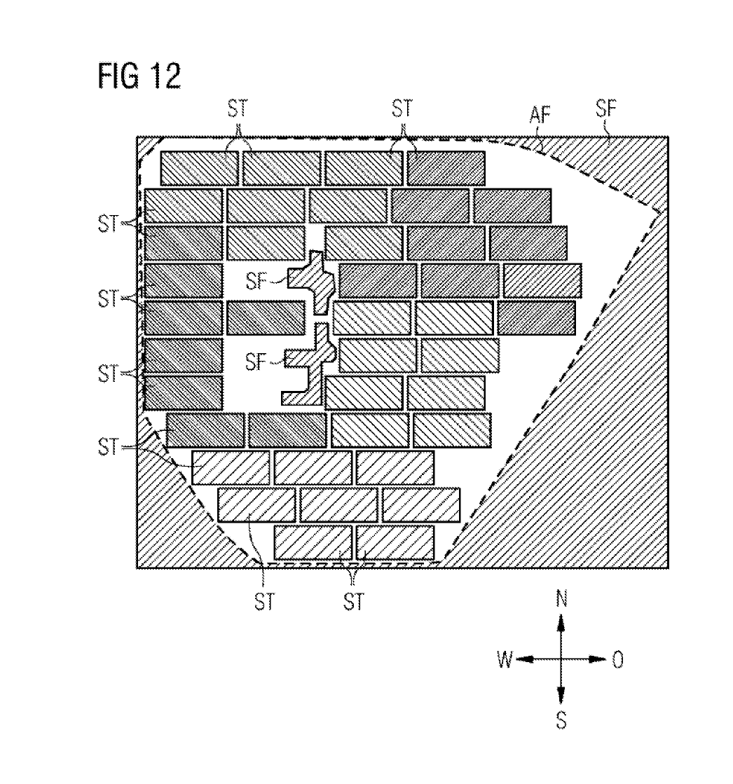

FIG. 12 shows a detailed excerpt of a second possible system layout of a configuration of a photovoltaic open-space power plant according to one possible embodiment of the method;

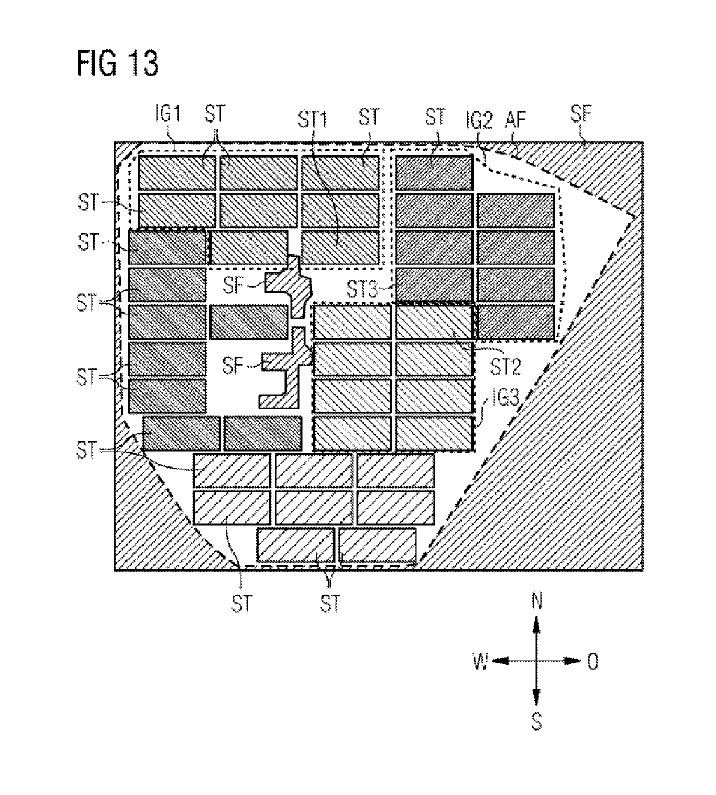

FIG. 13 shows a detailed excerpt of a third possible system layout of a configuration of a photovoltaic open-space power plant according to one possible embodiment of the method;

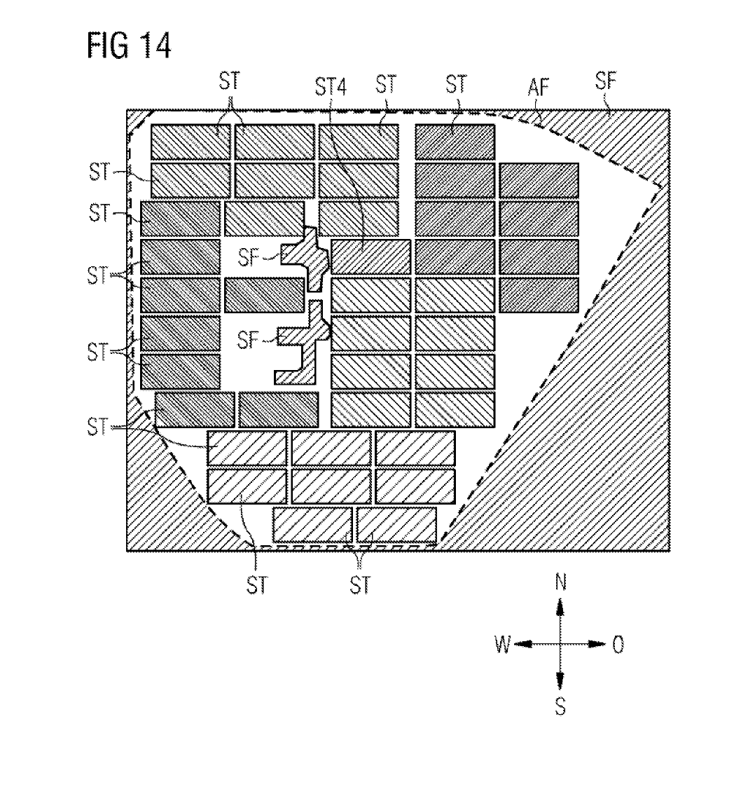

FIG. 14 shows a detailed excerpt of a fourth possible system layout of a configuration of a photovoltaic open-space power plant according to one possible embodiment of the method; and

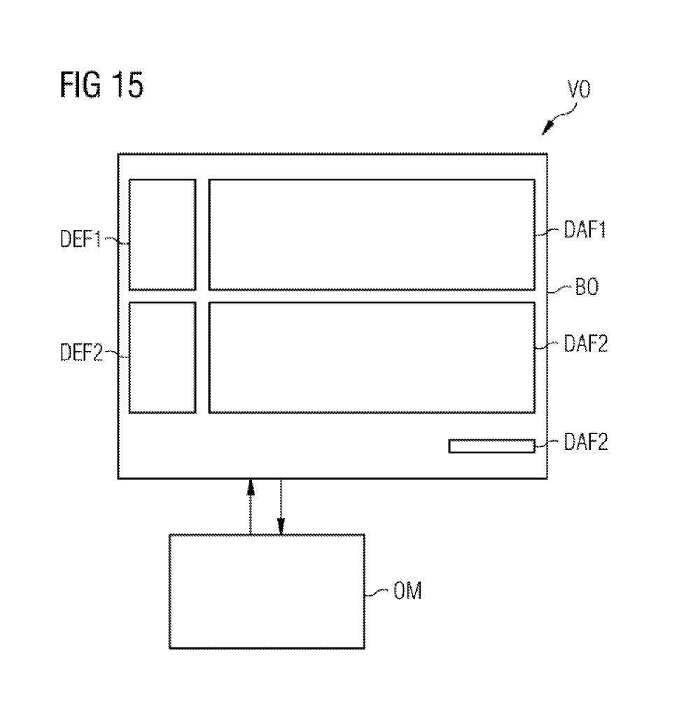

FIG. 15 shows an illustration of a user interface module for inputting data according to one possible embodiment of the method.

### DETAILED DESCRIPTION

In the figures of the drawing, identical reference symbols denote identical or functionally identical components or method steps, unless stated otherwise.

FIG. 1 shows an illustration of a flowchart of one possible embodiment of the method according to the invention for creating a system layout of a photovoltaic open-space power plant.

In a first step of the method, configuration data which specify the photovoltaic open-space power plant PV and its power plant components, configuration rules which are predefined for the photovoltaic open-space power plant PV, and configuration parameters which concretize the configuration rules are provided S1.

Power plant components are, for example, solar trackers, inverters, photovoltaic modules, solar cell strings, solar cell tables, connecting cables, coupling boxes, terminal boxes or inverter containers or other electrical module components.

In a second method step, both the number of required components of the photovoltaic open-space power plant PV and their positioning are stipulated for system layout properties by means of initialization and subsequent optimization S2 using the provided configuration data and the concretized configuration rules for creating the system layout of the photovoltaic open-space power plant PV.

The data provided also comprise, for example, circuitry secondary conditions or other standard conditions or safety guidelines for the photovoltaic open-space power plant PV. Placement secondary conditions or secondary conditions for electrical variables of power plant components such as maximum electrical current intensities or electrical voltages are provided, for example, as circuitry secondary conditions.

For example, the configuration rules can be concretized by stipulating specific values for the configuration parameters. Configuration data specify, for example, the system to be planned or the system layout of the photovoltaic open-space power plant PV.

For example, a configuration parameter of eight solar trackers ST for each inverter group IG concretizes the configuration rules with respect to interconnecting the solar trackers ST to form one inverter group IG.

FIG. 2 shows an illustration of a map view of an area to be planned for a photovoltaic open-space power plant according to one possible embodiment of the method according to the invention.

In an area G which is defined by its outline and possibly one or more barred areas SF, a photovoltaic open-space power plant PV is planned or erected in a system area AF, the configuration of the photovoltaic open-space power plant PV being optimized according to nominal power and/or costs and/or efficiency.

The area G to be planned is illustrated in the depicted orientation. The west-east orientation, W-O, is given by the x coordinate and the north-south orientation, N-S, is given by the y coordinate.

FIG. 3 shows an illustration of a solar tracker of a photovoltaic open-space power plant according to one possible embodiment of the device according to the invention.

A plurality of identical photovoltaic modules of a photovoltaic open-space power plant PV are connected in series to form so-called strings which are in turn connected to inputs of inverters of the photovoltaic open-space power plant PV in a parallel circuit. The possible number of photovoltaic modules in a string depends on the specification data for the inverters.

The specification data for the inverters are provided as data relating to the power plant components of the photovoltaic open-space power plant PV.

The photovoltaic modules which have been connected to form strings are mounted on a tracker frame on a solar tracker ST. The solar trackers ST are carrier systems which track the position of the sun and in which the carrier system, the mounted photovoltaic modules, the controller or similar components are matched to one another in an integrated manner, for example.

A tracker frame of the solar tracker ST comprises a plurality of parallel segments SG running in the north-south direction. In this case, all segments SG of the solar tracker ST are coupled to one another via a push rod which is driven by a motor M, runs centrally in the west-east direction and makes it possible to adapt the orientation of the module to the position of the sun from east to west over the course of the day.

At sunrise, all of the photovoltaic modules on the solar tracker ST are therefore oriented to the east. Over the course of the day, the inclination of the photovoltaic modules is then adapted in the best possible manner to the current position of the sun until the photovoltaic modules are oriented to the west at sunset. The position of the sun is tracked in the solar trackers ST by means of single-axis rotation of the segments SG of the solar trackers ST, for example.

FIG. 4 shows an illustration of a solar tracker of a photovoltaic open-space power plant according to one possible embodiment of the method according to the invention.

A solar tracker ST comprises a wing T, on which the photovoltaic modules are mounted, and a base F which is used to anchor the solar tracker ST in the ground.

A motor M is fitted between the base F and the wing T at the height H_{ST}, for example, and can rotate the wing T via a push rod SC, for example over an angular range of +/−45°. The push rod SC runs in the center of the segments SG in the west-east direction and therefore subdivides each segment SG into a north wing and a south wing T.

The specification of the tracker design of the solar tracker ST by the user includes, for example, the selection of a multiplicity of design and configuration parameters of the solar tracker ST, for example the selection of the module type used, the stipulation of the number of photovoltaic modules per wing T, including their mounting on the frame, the distance between a north wing and a south wing T of a segment SG, the distances between the segments SG in the west-east direction, the number of segments SG in the solar tracker ST and the cabling of the equipment inside the solar tracker ST, for instance the connection of the strings or the connection of the terminal boxes or inverters.

In particular, the extents of the rectangular outline of the solar tracker ST result from the tracker design of the solar tracker ST. When configuring the tracker design of the solar tracker ST, the user must heed both the electrical compatibility of the equipment used and restrictions with respect to the extents of the solar tracker ST in the west-east direction and in the north-south direction, for example on account of permissible wind loads.

FIG. 5 shows an illustration of an inverter group of a photovoltaic open-space power plant according to one possible embodiment of the method according to the invention.

FIG. 5 illustrates an inverter group IG having eight solar trackers ST, which is referred to as a standard block B on account of its rectangular arrangement. The center of FIG. 5 illustrates an inverter container WC1. FIG. 5 also illustrates the cable routing inside the inverter group IG. It is indicated how the cables are routed from the solar trackers ST to the inverter container WC1. A cable and service route W1 runs in the center of the photovoltaic open-space power plant PV in the north-south direction.

An inverter of the photovoltaic open-space power plant PV has, for example, a plurality of DC inputs to which a plurality of strings connected in parallel are connected. The number of strings to be connected to an inverter input results from the module data relating to the photovoltaic module, from the data relating to the inverter and from the configuration parameters and is flexible within a predefined corridor. This should be taken into account when stipulating the tracker design of the solar tracker ST.

A number of solar trackers ST which is defined by the user is assigned to each inverter, said solar trackers forming a so-called inverter group IG. The number of solar trackers ST in an inverter group IG is respectively determined by the fact that the resulting current intensity which is passed to the inverter of the inverter group IG is compatible with the electrical specification of said inverter and makes optimal use of the inverter capacities.

For this purpose, it may also be advantageous to combine differently configured solar trackers ST in an inverter group IG. The number of segments SG per solar tracker ST can therefore vary within an inverter group IG in order to make optimal use of the capacity of the inverter.

In order to enable cost-effective and efficient cabling, the inverter container should always be positioned close to the center of gravity of the inverter group IG. Therefore, a certain number of segments SG can also be eliminated from a solar tracker ST, with the result that the inverter container WC1 of the inverter group IG can be provided in the space which is obtained thereby.

In order to simplify the cabling and save material, the cables of a plurality of strings are combined in so-called generator terminal boxes. In a similar manner, the cables of a plurality of generator terminal boxes are combined in so-called coupling boxes. Each coupling box is then guided to a DC input of an inverter. One aim when placing the solar trackers ST and the inverters is to provide the best possible prerequisites for DC cabling which is as simple, efficient and cost-effective as possible.

FIGS. 6 and 7 show two different system layouts which, according to one possible embodiment of the device according to the invention, result from different specifications with respect to the arrangement of the solar trackers in the inverter groups. Only regular standard blocks could therefore be used as inverter groups IG according to one configuration rule when creating the configuration (shown in FIG. 6) of the photovoltaic open-space power plant PV (“standard blocks” application).

In contrast, FIG. 7 shows how the solar trackers of an inverter group can also be arranged, for example, if no restrictions need to be heeded during grouping (“any desired inverter groups” application).

The standard blocks in FIG. 6 make it possible to construct and service the system as easily and efficiently as possible. However, the available area, in particular at its edges, is not used in a particularly efficient manner, with the result that not much power is installed in the system shown in FIG. 6 in comparison with the possible system area.

FIG. 7 illustrates an application without restrictions on the solar tracker arrangement in the inverter groups IG of the photovoltaic open-space power plant PV. It can be easily seen that, in comparison with the system from FIG. 6, it was possible to position more inverter groups and the system therefore has more power. However, the resulting irregular system structures result in a considerably more complex system structure and also result, on average, in longer cables.

FIGS. 8 and 9 each show an illustration of a flowchart of one possible embodiment of the method according to the invention for creating a configuration of a photovoltaic open-space power plant with solar trackers which must be arranged in standard blocks (FIG. 8, “standard blocks” application) or which can be combined in any desired manner to form inverter groups (FIG. 9, “any desired inverter groups” application).

An optimizer of the method for creating a configuration of a photovoltaic open-space power plant PV with solar trackers ST subdivides the problem of system planning and creating a configuration of the photovoltaic open-space power plant PV into the following subproblems or subunits:

1. Locating the continuous west-east paths of the photovoltaic open-space power plant PV or defining strips for the solar trackers ST of the photovoltaic open-space power plant PV and initializing the solar tracker centers (both in the “standard blocks” application and in the “any desired inverter groups” application);

2. Initializing the inverter groups IG of the photovoltaic open-space power plant PV (only in the “any desired inverter groups” application);

3. Optimizing the west-east orientation of the solar tracker centers (both in the “standard blocks” application and in the “any desired inverter groups” application); and

4. Improving the inverter group division of the photovoltaic open-space power plant PV (only in the “any desired inverter groups” application).

The flowchart shown in FIG. 8 therefore results for the “standard blocks” application.

As a first method step in the “standard blocks” application, the continuous west-east paths are located S11 and the centers of the solar trackers ST are then initialized.

As a second method step in the “standard blocks” application, the west-east orientation of the centers of the standard blocks or solar trackers ST is optimized S12.

As a third method step in the “standard blocks” application, the method for creating a configuration of a photovoltaic open-space power plant with solar trackers is terminated S13.

The flowchart shown in FIG. 9 results for the “any desired inverter groups” application.

As a first method step in the “any desired inverter groups” application, the continuous west-east paths are located S21 and the centers of the solar trackers ST are initialized.

As a second method step, the inverter groups IG are initialized S22.

As a third method step in the “any desired inverter groups” application, the west-east orientation of the centers of the solar trackers ST is optimized S23.

As a fourth method step, the initialization of the inverter groups IG is optimized S24.

As a fifth method step, a check is carried out S25 in order to determine whether the optimization carried out in the fourth method step also resulted in an improvement.

If there is an improvement, the method is repeated from the third method step S23. Otherwise, the method for creating a configuration of a photovoltaic open-space power plant with solar trackers is continued with the sixth method step.

As a sixth method step, the method for creating a configuration of a photovoltaic open-space power plant with solar trackers is terminated S26.

In order to locate the continuous west-east paths and to define solar tracker strips and to initialize the centers of the solar trackers ST (substeps S11 and S21), the area G is first of all discretized in the north-south direction, for example using an area point grid with sufficiently finely selected, fixed distances in the point grid.

For each of the y coordinates resulting from the discretization, a check is then carried out in order to determine how many solar trackers ST for the “any desired inverter groups” application or standard blocks for the “standard blocks” application can be placed at the associated y coordinate within the area G and which residual capacity remains in the strip belonging to the y coordinate.

FIG. 10 shows an illustration of a detailed excerpt for placing the solar trackers or standard blocks according to one possible embodiment of the method according to the invention.

The lower y coordinate of the rectangular outline of a solar tracker ST or of a standard block B is always respectively used, for example, as the y coordinate in this case, as illustrated in FIG. 10.

The area G is bounded by an eastern site boundary OGZ and a western site boundary WGZ.

If the strip capacities have been determined for all y coordinates resulting from the discretization, those y coordinates which will actually be used as lower y coordinates of the solar trackers ST or standard blocks B in the system must then be selected.

The primary objective of this selection is to be able to position as many solar trackers ST or standard blocks B as possible in the available area. The subordinate aim is to strive for the highest possible residual capacity RK in the selected strips in order to have the greatest possible leeway when subsequently optimizing the x coordinates of the solar trackers ST or standard blocks B.

This subproblem is solved with the aid of dynamic programming.

The forward calculation begins at the southern edge of the area G and progresses to the northern edge of the area G using the methodology described below. For each row, a check is carried out in order to determine which row to the south of it would be the most favorable southern neighboring row so that the cumulated number of solar trackers ST or standard blocks B as far as the current y coordinate is at a maximum and the cumulated residual capacity RK is as large as possible as the subordinate aim.

In this case, it should also be noted, in particular, that space of at least one path width WB1, WB2 must always be preserved between two adjacent strips in the north-south direction, which space then corresponds to the continuous west-east paths through the area. The result of the forward calculation is therefore a table which, for each y coordinate, indicates not only the most favorable, permissible, southern neighboring row but also the maximum cumulated number of solar trackers ST or standard blocks which can be placed in the area G from the southern edge of the area to the relevant y coordinate, as well as the cumulated residual capacity RK of the relevant strips.

The backwards calculation now traces back, from the y coordinate with the largest cumulated number of solar trackers ST or standard blocks B and the greatest cumulated residual capacity RK—which is close to the northern edge of the area, in order to determine which are the most favorable southern neighboring rows in each case. This provides the y coordinates for all east-west strips through the area G and, at the same time, the coordinates of the continuous west-east paths.

The associated number of solar trackers ST or standard blocks B is now positioned without any overlapping in all selected strips; in this case, the associated x coordinates are initialized, in particular. This can be effected, for example, by means of the most western possible orientation of all solar trackers ST or standard blocks B, as is also illustrated in FIG. 10. Only the path widths WB1, WB2 which need to be complied with between each two adjacent solar trackers ST or standard blocks B should again be heeded.

The method for the subproblem described here can be schematically summarized as follows:

For the purpose of modeling, an input is first of all provided. The input comprises, for example, area data, dimensioning of the solar trackers ST or of the standard blocks and the path widths.

The following restrictions are also stipulated during modeling: placement of the solar trackers ST or the standard blocks B without any overlapping, compliance with the path widths between the strips and the solar trackers ST or standard blocks B.

The following are used as target functions during modeling for the purpose of optimizing a system layout property of the photovoltaic open-space power plant PV: maximization of the number of solar trackers ST or standard blocks B placed, maximization of the residual capacity cumulated over all selected strips.

This results in a data output in the form of a created system layout. The data output comprises, for example, y coordinates of the solar tracker strips, y coordinates of the continuous west-east paths, initial coordinates of the solar trackers ST or of the standard blocks B.

FIG. 11 is a possible result for the “any desired inverter groups” application. FIG. 11 shows the result of this solved subproblem for optimizing a system layout property of the photovoltaic open-space power plant PV for a site having two central barred areas SF.

FIG. 12 shows a detailed excerpt of a possible system layout of a configuration of a photovoltaic open-space power plant according to one possible embodiment of the method according to the invention.

The method used to calculate the configuration illustrated in FIG. 12 comprises initialization of the inverter groups IG (substep S22) and is based on the coordinates of the solar trackers ST which were determined in the preceding subproblem and are not changed in this substep. The aim of this substep is to divide the solar trackers into inverter groups which are as compact as possible.

Since the number N of placed solar trackers ST is generally not a multiple of the number M of solar trackers ST per inverter group IG, the possibly excess numbers must initially be eliminated, for example by means of a division with a remainder. The objective of the removal may be, for example, to remove the solar trackers ST with the fewest direct neighbors or else to make the area occupied by the solar trackers ST which have not been eliminated as compact as possible, that is to say the wish is to achieve the shortest possible extent of the actually used area in the east-west and north-south directions.

Both of the proposed alternative aims can be achieved within the scope of simple greedy heuristics or mixed-integer programs. After the decision regarding which solar trackers ST should not be taken into account when initializing the inverter groups IG, the inverter groups IG are first of all determined with the aid of greedy heuristics, for example.

In this case, the procedure may be such, for example, that the solar tracker with the fewest neighbors is respectively determined among the solar trackers ST which have not yet been assigned to an inverter group IG and the locally best possible inverter group IG, that is to say the inverter group which is as compact as possible for example, is formed for this solar tracker from the solar trackers ST which still remain and have not yet been assigned. This methodology is then continued until all solar trackers ST which have not been eliminated have been assigned to an inverter group IG.

After the greedy heuristics described, an attempt can be made to improve the initialization of the inverter groups IG using a local improvement method. This can be carried out, for example, using a simple location allocation method which comprises two steps which are alternately carried out until no further improvements can be achieved.

In a first step, for all current inverter groups IG, the center of gravity of all solar trackers ST in this inverter group IG is respectively determined.

In the second step, the calculated centers of gravity of the inverter groups IG are fixed and the solar trackers ST are then reassigned to the inverter groups IG. This can be carried out with the aid of a mixed-integer method, the objective of which is to minimize the sum of all distances between the solar trackers ST and the fixed centers of gravity of the associated inverter groups IG. Only the compliance with the sizes of the inverter groups IG must be taken into account as a secondary condition in this case.

Another possible procedure when initializing the inverter groups IG is to alternatively apply the greedy heuristics described above directly to all available solar trackers ST. In this case, the upstream elimination of excess solar trackers ST is dispensed with here. The greedy heuristics then naturally end when there are no longer sufficient solar trackers ST, which have not yet been assigned, to form a further group of solar trackers ST.

The important substep in the method for initializing the inverter groups therefore lies in the greedy heuristics described. It is also possible to dispense with both the upstream elimination of excess solar trackers ST and with the downstream local improvement method described, if necessary. The method for the subproblem (described here) of optimizing a system layout property of a photovoltaic open-space power plant PV can be schematically summarized as follows:

During modeling, the coordinates of the solar trackers ST and the number of solar trackers ST per inverter group IG are respectively used to initialize the inverter groups.

The restriction used is that each inverter group IG has precisely the number of solar trackers ST predefined by the user. Minimization of the distances between the solar trackers ST inside an inverter group IG and the associated center of gravity of the inverter group IG and improvement of the compactness of the determined inverter group IG, that is to say the shortest possible extent of the inverter group IG in the x and y directions, are used as target functions.

Initialization of the inverter groups IG is thereby achieved as the output of the method.

Greedy heuristics, mixed-integer programs and local solution methods or combinations thereof are used as solution methods.

FIG. 13 shows a detailed excerpt of a possible system layout of a configuration of a photovoltaic open-space power plant according to one possible embodiment of the method according to the invention.

The fundamental objective of the method used to calculate the configuration illustrated in FIG. 13 is an optimized west-east orientation of the solar tracker centers (substep S12 or S23).

This provides the best possible prerequisites for simple, efficient and cost-effective cabling. For the cabling on the DC side, it is advantageous to have north-south paths which are as continuous as possible within the inverter groups IG for this purpose. This is always the case in the “standard blocks” application on account of the regular arrangement of all solar trackers ST in the inverter group IG.

In contrast, in the “any desired inverter groups” application, the available flexibility with respect to the arrangement of the solar trackers ST in the x direction should be used to allocate x coordinates which are as identical as possible to the solar trackers ST in an inverter group IG which have different y coordinates.

This means that the solar trackers ST in an inverter group IG which are in different strips must be oriented to one another with respect to their west-east orientation.

Since the cabling on the DC side comprises considerably more cable than the cabling on the AC side of a photovoltaic open-space power plant, the continuous north-south paths within the inverter group IG have the highest priority.

Nevertheless, the described principle can also be transferred from the individual solar trackers ST in an inverter group IG to entire inverter groups IG which are then likewise oriented to one another with respect to their west-east orientation.

This applies, in particular, to the “standard blocks” application since the north-south paths within the inverter groups IG are always continuous there anyway and there is also often more leeway for positioning the solar trackers ST or standard blocks B when optimizing the x coordinates on account of the generally lower degree of area occupancy in comparison with the degree of area occupancy in the “any desired inverter groups” application.

If there are approximately equally well-suited configurations for the above-mentioned objective for a photovoltaic open-space power plant, that configuration which has the shortest extent in the west-east direction with respect to the actually used area will preferably always be selected since the length of the required cables carrying alternating current can therefore be kept as short as possible.

A suitable method for solving the subproblem described is mixed-integer programming. In this case, the different alternative orientations of the solar trackers ST are modeled with the aid of binary, that is to say special integer variables. Depending on the alternative selected during optimization, a solar tracker ST is then oriented either to its left-hand upper neighbor or its right-hand upper neighbor, for example.

The secondary conditions which need to be taken into account during mixed-integer programming are clear from the following schematic summary of the method for optimizing the west-east orientation of the centers of the solar trackers ST.

During modeling, the area boundaries of the system area AF, including the barred areas SF of the area G, current inverter groups IG, y coordinates of all solar trackers ST, path widths WB1, WB2 . . . WBn of the cable and service routes of the photovoltaic open-space power plant PV are required as the input.

The restriction used, for example, is placement of the solar trackers ST in all inverter groups IG without any overlapping or the configuration rule stating that area boundaries of the area G must not be infringed or that the path widths WB1, WB2 . . . WBn between the strips and solar trackers ST or standard blocks B of the photovoltaic open-space power plant PV must be complied with.

The fact that the strip affiliation or the y coordinate of all solar trackers ST or all standard blocks B of the photovoltaic open-space power plant PV remains unchanged, that is to say only the x coordinates are variable, can also be stated as a restriction.

In the “standard blocks” application, the relative position of all solar trackers ST or standard blocks B in an inverter group IG of the photovoltaic open-space power plant PV with respect to one another remains unchanged.

The following target functions which are organized as follows with respect to the prioritization, beginning with the target function with the highest priority, are used as target functions:

north-south paths which run as straight as possible within the inverter groups IG of the photovoltaic open-space power plant PV have the highest priority so that the cabling on the DC side is as simple as possible. In comparison with this, a lower priority results for straight north-south paths which encompass inverter groups and additionally simplify the AC cabling;
the shortest possible extent of all inverter groups IG of the photovoltaic open-space power plant PV in the west-east direction; and
the shortest possible extent of the system area AF actually used by the photovoltaic open-space power plant PV.

Exact positions of all solar trackers ST or all standard blocks B of the photovoltaic open-space power plant PV are output as the output. The mixed-integer programming is used as the solution method.

FIG. 13 illustrates the inverter group placements which are obtained as the result of optimizing the x coordinates for the starting situation illustrated in FIG. 12.

The inverter group division is improved as the next subunit (substep S24).

The objective of this subunit is to make improvements to the current inverter group assignment, starting from the current positions of the solar trackers ST, the positions of the solar trackers ST not being changed in this substep, in order to obtain inverter groups IG having an outline which is as compact as possible and in order to obtain shorter distances between the solar trackers ST and the centers of gravity of the inverter groups.

Three quick swap methods are described below for this purpose.

In the so-called 2-swap method, a check is carried out, for each pair of two solar trackers ST from different inverter groups IG, in order to determine whether a swap of the inverter group assignment for these two solar trackers ST results in an improvement with regard to the aims described in the preceding paragraph. If this is the case, a corresponding swap is carried out, otherwise not.

The so-called 3-swap method is mainly based on the 2-swap method, apart from the fact that here the inverter group assignments of three solar trackers ST from different inverter groups IG of the photovoltaic open-space power plant PV are cyclically swapped.

If the solar trackers ST1, ST2 and ST3 therefore belong to the inverter groups IG1, IG2 and IG3 in the original assignment, a check is carried out in order to determine whether or not the cyclical swap of the inverter group assignments results in an improvement with respect to the above-mentioned aims.

A corresponding check can be carried out for all groups of three solar trackers ST from different inverter groups IG.

The substitution method is based on a different idea: in this case, a check is carried out in order to determine whether there is still reserve space in the area G in the current layout which is sufficient to position a solar tracker ST which can then replace a solar tracker ST existing in the current layout in its inverter group IG if this results in an improvement with regard to the above-mentioned aims.

Such reserve space may exist if not all solar trackers ST could be assigned to an inverter group IG when initializing the inverter groups IG. Naturally, the conventional placement rules with regard to crossing of the area boundaries, the west-east strips and the path widths should be heeded when placing the new solar tracker ST. The swap methods described can be schematically summarized as follows:

During modeling, the following are used here as the input: the exact positions of all solar trackers, the current inverter group IG, the number of solar trackers ST per inverter group IG, the area boundaries including the barred areas SF, and the dimensioning of the solar trackers ST and the path widths provided.

The retention of the positions of all solar trackers ST used is used as restrictions. Furthermore, area boundaries must not be infringed. Placement of the solar trackers ST or of the standard blocks B without any overlapping is stipulated and compliance with the path widths between the strips and solar trackers ST or standard blocks B is provided as further restrictions. Furthermore, the continuous west-east paths through the area G should be retained. Each inverter group IG comprises the number of solar trackers ST predefined by the user.

The following functions are used as target functions:
minimization of the distances between the solar trackers ST within an inverter group IG and the associated center of gravity of the inverter group IG; and
making the determined inverter groups IG compact, that is to say the shortest possible extent of the groups in the x and y directions.

As a result, new inverter groups IG with respect to the grouping of the solar trackers ST are provided as the output. In this case, the 2-swap method, the 3-swap method and the substitution method are used as solution methods.

In the 2-swap method, the inverter group assignment of two solar trackers ST which have already been placed from different inverter groups IG is swapped.

In the 3-swap method, the inverter group assignment of three solar trackers ST which have already been placed from different inverter groups IG is cyclically swapped.

In the substitution method, an existing solar tracker ST within an inverter group IG is replaced with a solar tracker ST4 newly placed in the existing layout.

FIG. 14 shows a detailed excerpt of a possible system layout of a configuration of a photovoltaic open-space power plant according to one possible embodiment of the method according to the invention.

For the starting position illustrated in FIG. 13, FIG. 14 illustrates the checking of a substitution of a newly placed solar tracker ST4. In this case, an improvement would not result for any of the five inverter groups IG if the solar tracker ST4 were added to an inverter group IG and one of the existing solar trackers ST were removed from the relevant inverter groups IG for this purpose.

Since no changes are made to this layout in the “2-swap” and “3-swap” substeps either, the improvement in the inverter group division remains unsuccessful here and the method is terminated, as is illustrated in the flowchart shown in FIG. 9.

A possible expansion for the presented method is described below.

In order to be able to provide better prerequisites with regard to efficient, cost-effective and simple cabling in the “any desired inverter groups” application, an additional parameter is introduced within the scope of this expansion, which parameter can be used by the user to specify how many inverter groups are voluntarily dispensed with when using the available area to the benefit of flexibility when optimizing the west-east orientation of the centers of the solar trackers ST.

The idea therefore involves artificially reducing the installed nominal power in order to be able to achieve more skilled cabling for this purpose. The method then proceeds in a similar manner to the previous embodiments, apart from the fact that the number of solar trackers which are eliminated is accordingly increased when locating the continuous west-east paths, that is to say when defining the strips, and initializing the tracker centers.

Consequently, fewer inverter groups are placed in the area, which automatically increases the flexibility with respect to the x coordinates within the west-east tracker strips. The chances of continuous north-south paths within the inverter groups IG when optimizing the west-east orientation of the tracker centers are therefore increased.

The generally complex problem of planning the system layout of photovoltaic open-space power plants with solar trackers is therefore, in summary, broken down into a hierarchical system of smaller subproblems. The solution to the overall problem is then composed of the solutions to the subproblems. In order to solve the subproblems, tailored mathematical models and methods were designed which allow automation, significantly reduce planning times and calculate qualitatively very good layouts.

The previously very complicated layout planning which had to be individually carried out for each system can be considerably simplified, accelerated and improved by the method according to embodiments of the invention.

FIG. 15 shows an illustration of a user interface module for inputting data according to one possible embodiment of the device according to the invention.

A device VO for creating a system layout of a photovoltaic open-space power plant PV comprises an optimization module OM and a user interface module BO.

For example, special windows are defined and shown in a graphical or character-oriented user interface as dialog windows or dialog fields or dialog boxes.

For example, the user interface module BO comprises a multiplicity of dialog windows which are constructed in a form-like manner and are provided for inputting data. Standard widgets such as data display fields DAF1-DAF3 and checkboxes are used for this purpose, for example.

The user interface module BO also has data input fields DEF1-DEF2 and, as a result, provides the required functionalities for inputting and managing the basic data, for example data relating to the solar trackers ST, data relating to the types of inverters used or data relating to the area G and possibly further data.

The area data input dialog makes it possible to define area and barred area outlines for the area G.

A further menu may have functionalities for selecting area data and components and for inputting parameters. In addition, information, for instance relating to the results of a physical or circuitry test of the solar cell table arrangement, is presented, for example.

For example, after clicking a button, an optimization run is started and an optimization page is opened. Brief information relating to the optimization order currently being processed by the optimization module and a status display which provides information on the program progress appear.

After the optimization run has ended, a brief summary of the results appears. The results are processed in detail by clicking a further button.

The report page opens after the processing of the results has ended. The optimization results can be displayed in the form of graphics with an interaction and zoom function or as result or data lists.

Although embodiments of the invention have been illustrated and described in detail by the exemplary embodiments described above, the invention is not restricted by the disclosed examples and other variations can be derived therefrom by a person skilled in the art without departing from the scope of protection of embodiments of the invention.

### LIST OF REFERENCE SYMBOLS

S1 Provision
S2 Initialization and subsequent optimization
S11 Localization
S12 Optimization
S13 Termination
S21 Localization
S22 Initialization
S23 Optimization
S24 Optimization
S25 Checking
S26 Termination
PV Photovoltaic open-space power plant
G Area
SF Barred area
AF System area
ST Solar tracker
SG Segments
M Motor
W1 Service route
T Wing
F Base
SC Push rod
B Standard block
WC1 Inverter container
IG Inverter group
I Inverter
RK Residual capacity
WB1, WB2 Path width
OGZ Eastern site boundary
WGZ Western site boundary
IG1 . . . IG3 Inverter groups
ST1, ST2, ST3, ST4 Solar trackers
VO Device
OM Optimization module
BO User interface module
DEF1-DEF2 Data input fields
DAF1-DAF3 Data display fields

1. A method for creating a system layout of a photovoltaic open-space power plant having power a plurality of power plant components, comprising the following method steps:
providing configuration data which specify the photovoltaic open-space power plant and the plurality of power plant components, configuration rules which are predefined for the photovoltaic open-space power plant, and configuration parameters which concretize the configuration rules; and
initializing and subsequently optimizing a selection and positioning of required power plant components for system layout properties of the photovoltaic open-space power plant using the provided configuration data and the concretized configuration rules for creating the system layout of the photovoltaic open-space power plant.

2. The method as claimed in claim 1, wherein, in order to create the system layout of the photovoltaic open-space power plant, a path configuration of the photovoltaic open-space power plant is calculated for the purpose of optimizing one of the system layout properties.

3. The method as claimed in claim 1, and wherein, in order to create the system layout of the photovoltaic open-space power plant, a number of the plurality of power plant components of the photovoltaic open-space power plant is calculated for the purpose of optimizing one of the system layout properties.

4. The method as claimed in claim 1, wherein, in order to create the system layout of the photovoltaic open-space power plant, a positioning of a plurality of solar trackers of the photovoltaic open-space power plant is calculated for the purpose of optimizing one of the system layout properties.

5. The method as claimed in claim 1, wherein, in order to create the system layout of the photovoltaic open-space power plant, an assignment of the plurality of solar trackers to inverter groups of the plurality of power plant components of the photovoltaic open-space power plant is calculated for the purpose of optimizing one of the system layout properties.

6. The method as claimed in claim 4, wherein the calculation of the positioning of the plurality of solar trackers of the photovoltaic open-space power plant and the calculation of the assignment of the plurality of solar trackers to the inverter groups are repeatedly alternately carried out during a local improvement method.

7. The method as claimed in claim 1, wherein the number of the plurality of solar trackers of the photovoltaic open-space power plant is maximized for the purpose of optimizing one of the system layout properties.

8. The method as claimed in claim 1, wherein the creation of the system layout of the photovoltaic open-space power plant comprises checking a compatibility of the provided plurality of power plant components with one another.

9. The method as claimed in claim 1, wherein data relating to a position and/or an outline of an area intended for the photovoltaic open-space power plant are provided as the configuration data.

10. The method as claimed in claim 1, wherein an optimization module having a plurality of algorithms is used to create the system layout of the photovoltaic open-space power plant, wherein the optimization module uses a plurality of calculation methods which are used to plan and install the photovoltaic open-space power plant.

11. The method as claimed in claim 10, wherein a user interface module is used to carry out the method, wherein the user interface module is in the form of a graphical user interface and/or has functionalities for inputting data and/or for managing data and/or for outputting data and/or is designed to call the optimization module and/or to display results.

12. The method as claimed in claim 10, wherein at least one of the plurality of algorithms in the optimization module is designed to maximize a number of the plurality of solar trackers of the photovoltaic open-space power plant using a target function.

13. A device for creating a system layout of a photovoltaic open-space power plant having a plurality of power plant components, the device having an optimization module which is designed to:
provide configuration data which specify the photovoltaic open-space power plant and the plurality of power plant components, configuration rules which are predefined for the photovoltaic open-space power plant, and configuration parameters which concretize the configuration rules; and
initialize and then optimize a selection and positioning of required power plant components for system layout properties of the photovoltaic open-space power plant using the provided configuration data and the concretized configuration rules in order to create the system layout of the photovoltaic open-space power plant.

14. A computer program for carrying out the method as claimed in claim 1.

15. The device of claim 13, wherein the plurality of power plant components includes a plurality of solar trackers.
